(19) United States
(12) Patent Application Publication
(10) Pub. No.: US 2015/0237554 A1
(43) Pub. Date: Aug. 20, 2015

(54) SYSTEMS, METHODS AND APPARATUS FOR SEAMLESS HANDOFF AT THE APPLICATION LAYER BETWEEN DISPARATE NETWORKS FOR INTERACTIVE APPLICATIONS

(71) Applicant: QUALCOMM Incorporated, San Diego, CA (US)

(72) Inventors: David William Craig, San Diego, CA (US); Michael Tsimring, San Diego, CA (US); John Wallace Nasielski, San Diego, CA (US); Satashu Goel, San Diego, CA (US)

(21) Appl. No.: 14/621,005

(22) Filed: Feb. 12, 2015

Related U.S. Application Data
(60) Provisional application No. 61/941,997, filed on Feb. 19, 2014.

(51) Int. Cl. H04W 36/18; H04W 36/00

(52) U.S. Cl. CPC H04W 36/18; H04W 36/0094; H04W 36/0055

(57) ABSTRACT

Systems, methods and apparatus for communication are provided. In one aspect, a method of communication for an application running on an application layer of a first wireless host is provided. The method comprises communicating, via the application layer, a first data flow to a second wireless host over a first application connection on a first access network. The method further comprises determining, at the application, one or more channel quality metrics of each of the first application connection and an accessible second application connection on a second access network based on channel quality metrics. The method further comprises establishing, via the application layer, the second application connection with the second wireless host over the second access network based on the one or more channel quality metrics of one both of the first and second application connections.

### CLAIM OF PRIORITY UNDER 35 U.S.C. §119

This Application claims priority to Provisional Application No. 61/941,997 entitled “SYSTEMS, METHODS, AND APPARATUS FOR SEAMLESS HANDOFF AT THE APPLICATION LAYER BETWEEN DISPARATE NETWORKS FOR INTERACTIVE APPLICATIONS” filed Feb. 19, 2014. The disclosure of Provisional Application No. 61/941,997 is hereby expressly incorporated in its entirety by reference herein.

### BACKGROUND

1. Field

Certain aspects of the present disclosure generally relate to wireless communications, and more particularly, to systems, apparatus and methods for providing seamless handoff at the application layer between disparate access networks for interactive applications.

2. Background

The use of interactive applications, such as real time voice and video chat applications, has become commonplace on mobile wireless devices, such as smartphones. Such applications require an access network connection between at least two participants on separate devices. It is a common occurrence that one of the mobile wireless devices moves from a location where only a first access network may provide access network connectivity to another location where a second access network may also provide access network connectivity for and during an active session. The first and second access networks may be managed by different service providers, or by end users. Upon changing locations, it may be desirable to switch from the first access network to the second access network for any number of reasons. Accordingly, systems, apparatus and methods for providing seamless handoff at the application layer between disparate access networks for interactive applications are desirable.

### SUMMARY

Various implementations of systems, methods and devices within the scope of the appended claims each have several aspects, no single one of which is solely responsible for the desirable attributes described herein. Without limiting the scope of the appended claims, some prominent features are described herein.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

One aspect of the disclosure provides a method of communication for an application running on an application layer of a first wireless host. The method comprises communicating, via the application layer, a first data flow to a second wireless host over a first application connection on a first access network. The method further comprises determining, at the application, one or more channel quality metrics of each of the first application connection and an accessible second application connection on a second access network. The method further comprises establishing, via the application layer, the second connection with the second wireless host over the second access network based on the one or more channel quality metrics of one or both of the first and second application connections.

Another aspect of the disclosure provides a first wireless host for wireless communication. The first wireless host comprises a processor running an application on an application layer. The processor is further configured to communicate, via the application layer, a first data flow to a second wireless host over a first application connection on a first access network. The processor is further configured to determine, at the application, one or more channel quality metrics of each of the first application connection and an accessible second application connection on a second access network. The processor is further configured to establish, via the application layer, the second application connection with the second wireless host over the second access network based on the one or more channel quality metrics of one or both of the first and second application connections.

Another aspect of the disclosure provides a non-transitory, computer-readable medium comprising code. The code, when executed, causes a first wireless host running an application on an application layer to communicate, via the application layer, a first data flow to a second wireless host over a first connection on a first access network. The code, when executed, further causes the device to determine, at the application, one or more channel quality metrics of each of the first connection and an accessible second connection on a second access network based on channel quality metrics. The code, when executed, further causes the device to establish, via the application layer, the second connection with the second wireless host over the second access network based on the one or more channel quality metrics of one or both of the first and second connections.

Another aspect of the disclosure provides a first wireless host for wireless communication. The wireless host comprises means for running an application on an application layer of the first wireless host. The wireless host further comprises means for communicating, via the application layer, a first data flow to a second wireless node over a first connection on a first access network. The wireless host further comprises means for determining, at the application, one or more channel quality metrics of each of the first connection and an accessible second connection on a second access network. The wireless host further comprises means for establishing, via the application layer, the second connection with the second wireless node over the second access network based on the one or more channel quality metrics of one or both of the first and second connections.

### BRIEF DESCRIPTION OF THE DRAWINGS

FIG. 1 illustrates an example of a communication system in which aspects of the present disclosure may be employed.

FIG. 2 illustrates various components that may be utilized in a device that may be employed within the communication system of FIG. 1.

FIG. 3 is a diagram illustrating an exemplary architecture of the communication device of FIG. 2, in accordance with some implementations.

FIG. 4 illustrates an exemplary communication system in which a second access network becomes available while communicating over a first access network connection, in accordance with some implementations.

FIG. 5 illustrates the exemplary communication system of FIG. 4 where a second access network connection is established while communicating over the first access network connection, in accordance with some implementations.

FIG. 6 illustrates the exemplary communication system of FIG. 5 where the first access network connection is closed while communicating over the second access network connection, in accordance with some implementations.

FIG. 7 is an exemplary state diagram for the switching peer of FIGS. 4-6, in accordance with some implementations.

FIG. 8 is an exemplary state diagram for the receiving peer of FIGS. 4-6, in accordance with some implementations.

FIG. 9 is a diagram illustrating an exemplary operation of a deskew buffer, in accordance with some implementations.

FIG. 10 illustrates an exemplary call flow diagram for detection of a second access network connection while communicating over a first access network connection, in accordance with some implementations.

FIG. 11 illustrates an exemplary call flow diagram for a setup of a second application layer connection using the second access network connection while communicating over a first access network connection, in accordance with some implementations.

FIG. 12 illustrates an exemplary call flow diagram for a condition where an access network connection goes down while in the bicast state, in accordance with some implementations.

FIG. 13 illustrates an exemplary call flow diagram of the bicast state as described in FIG. 5, in accordance with some implementations.

FIG. 14 illustrates an exemplary call flow diagram for the paring procedure as described in FIG. 6, in accordance with some implementations.

FIG. 15 illustrates an exemplary call flow diagram of a queued handoff detection event as described in FIG. 7, in accordance with some implementations.

FIG. 16 illustrates an exemplary call flow diagram for a race condition where both peers attempt to perform a setup similar to that described in connection with FIG. 11, in accordance with some implementations.

FIG. 17 is a flow chart for a method of communication, in accordance with some implementations.

FIG. 18 is a functional block diagram of an exemplary wireless host for wireless communication, in accordance with some implementations.

### DETAILED DESCRIPTION

Various aspects of the novel systems, apparatuses, and methods are described more fully hereinafter with reference to the accompanying drawings. The teachings of this disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, and methods disclosed herein, whether implemented independently of or combined with any other aspect of the invention. For example, an apparatus may be implemented or a method may be practiced using any number of the aspects set forth herein. In addition, the scope of the invention is intended to cover such an apparatus or method which is practiced using other structure, functionality, or structure and functionality in addition to or other than the various aspects of the invention set forth herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, access networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Wireless access network technologies may include various types of wireless local area access networks (WLANs). A WLAN may be used to interconnect nearby devices together, employing widely used access networking protocols. The various aspects described herein may apply to any communication standard, such as Wi-Fi or, more generally, any member of the IEEE 802.11 family of wireless protocols.

In some implementations, a WLAN includes various devices which are the components that access the wireless access network. For example, there may be two types of devices: access points (“APs”) and clients (also referred to as stations, or “STAs”). In general, an AP serves as a hub or base station for the WLAN and an STA serves as a user of the WLAN. For example, a STA may be a laptop computer, a personal digital assistant (PDA), a mobile phone, etc. In an example, an STA connects to an AP via a Wi-Fi (e.g., IEEE 802.11 protocol such as 802.11ah) compliant wireless link to obtain general connectivity to the Internet or to other wide area access networks. In some implementations an STA may also be used as an AP.

An access point (“AP”) may comprise, be implemented as, or known as a NodeB, Radio Access network Controller (“RNC”), eNodeB, Base Station Controller (“BSC”), Base Transceiver Station (“BTS”), Base Station (“BS”), Transceiver Function (“TF”), Radio Router, Radio Transceiver, Basic Service Set (“BSS”), Extended Service Set (“ES S”), Radio Base Station (“RB S”), or some other terminology.

A station (“STA”) may also comprise, be implemented as, or known as a user terminal, an access terminal (“AT”), a subscriber station, a subscriber unit, a mobile station, a remote station, a remote terminal, a user agent, a user device, a user equipment, or some other terminology. In some implementations an access terminal may comprise a cellular telephone, a cordless telephone, a Session Initiation Protocol (“SIP”) phone, a wireless local loop (“WLL”) station, a personal digital assistant (“PDA”), a handheld device having wireless connection capability, or some other suitable processing device connected to a wireless modem. Accordingly, one or more aspects taught herein may be incorporated into a phone (e.g., a cellular phone or smartphone), a computer (e.g., a laptop), a portable communication device, a headset, a portable computing device (e.g., a personal data assistant), an entertainment device (e.g., a music or video device, or a satellite radio), a gaming device or system, a global positioning system device, or any other suitable device that is configured to communicate via a wireless medium.

The techniques described herein may be used for various broadband wireless communication systems, including communication systems that are based on an orthogonal multiplexing scheme. Examples of such communication systems include Spatial Division Multiple Access (SDMA), Time Division Multiple Access (TDMA), Orthogonal Frequency Division Multiple Access (OFDMA) systems, Single-Carrier Frequency Division Multiple Access (SC-FDMA) systems, and so forth. An SDMA system may utilize sufficiently different directions to concurrently transmit data belonging to multiple user terminals. A TDMA system may allow multiple user terminals to share the same frequency channel by dividing the transmission signal into different time slots, each time slot being assigned to different user terminal. A TDMA system may implement GSM or some other standards known in the art. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An OFDM system may implement IEEE 802.11 or some other standards known in the art. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA. A SC-FDMA system may implement 3GPP-LTE (3rd Generation Partnership Project Long Term Evolution) or other standards.

In the present application, the term “host” may correspond to any node that is not a router, e.g., a node that does not forward data packets not explicitly addressed to itself (end node within a network).

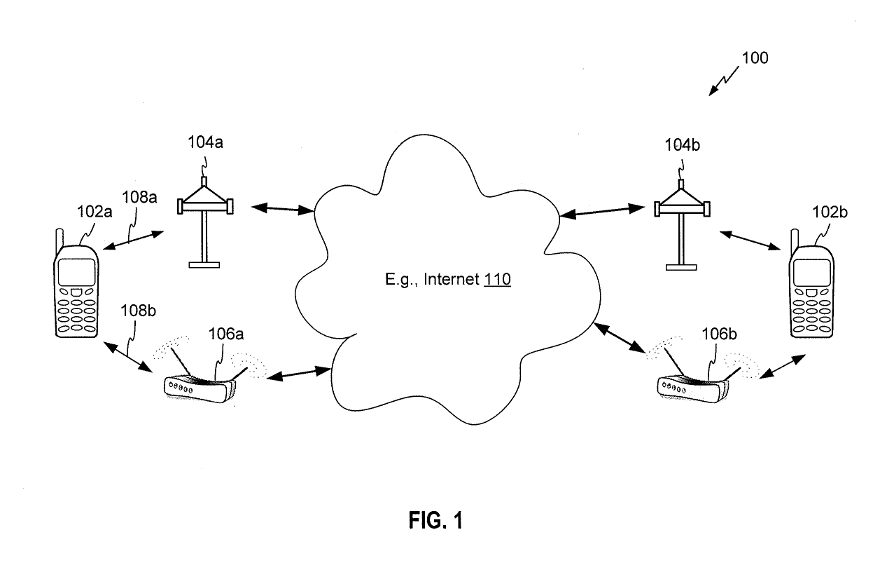

FIG. 1 illustrates an example of a communication system in which aspects of the present disclosure may be employed. At least a portion of the communication system 100 may operate pursuant to a wireless standard, for example at least one of the 802.11ah, 802.11ac, 802.11n, 802.11g and 802.11b standards. The communication system 100 may include a first STA 102a and a second STA 102b. The STAs 102a and 102b may communicate with one another, utilizing an interactive application, for example a video chat application, over one or both of a first access network connection 108a and a second access network connection 108b. For example and not limitation, the first access network connection108a may comprise a 3G, 4G, or 4G LTE cellular access network connection to a first BS 104a located near the first STA 102a and a second BS 104b located near the second STA 102b. The BSs 104a and 104b may communicate with each other over a central network, for example, internet 110. The second access network connection 108b may comprise a Wi-Fi network, for example, and may include a first AP 106a located near the first STA 102a and a second AP 106b located near the second STA 102b. The APs 106a and 106b may communicate with each other over the internet 110, for example. Although the above explanation intimates that a cellular access network connection at the first STA 102a is linked with a cellular access network connection at the second STA 102b, the present application is not so limited and either of a cellular access network connection or a Wi-Fi access network connection at the first STA 102a may be linked with either of a cellular access network connection or a Wi-Fi access network connection at the second STA 102b via the internet 110, for example.

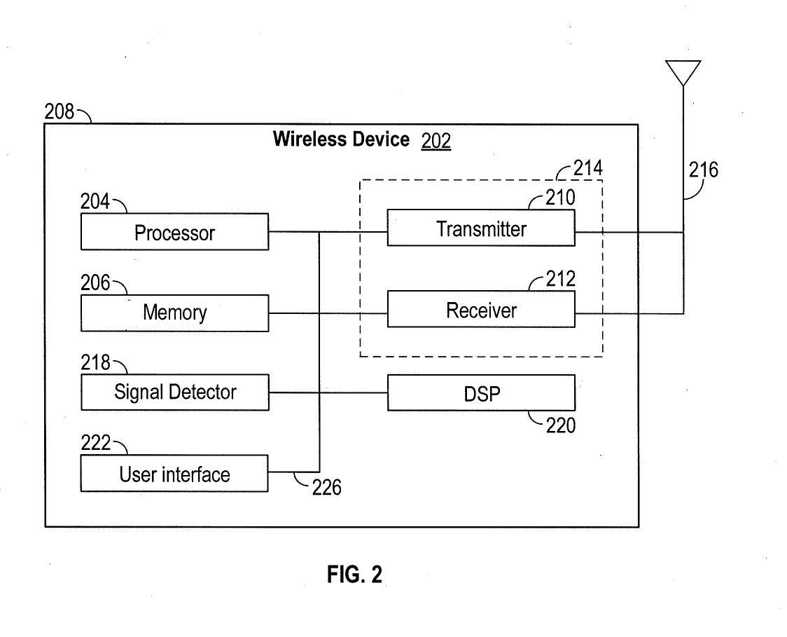

FIG. 2 illustrates various components that may be utilized in a device that may be employed within the communication system of FIG. 1. The device 202 may be a wireless device for example, but the present application is not so limited. The device 202 is an example of a device that may be configured to implement the various methods described herein. The device 202 may comprise one or both of the STAs 102a and 102b.

The device 202 may include a processor 204 which controls operation of the device 202. The processor 204 may also be referred to as a central processing unit (CPU) or hardware processor. Memory 206, which may include both read-only memory (ROM) and random access memory (RAM), may provide instructions and data to the processor 204. A portion of the memory 206 may also include non-volatile random access memory (NVRAM). The processor 204 typically performs logical and arithmetic operations based on program instructions stored within the memory 206. The instructions in the memory 206 may be executable to implement the methods described herein.

The processor 204 may comprise or be a component of a processing system implemented with one or more processors. Thus, where one or more operations are performed by the processor 204, the operations may be performed by a single processor 204, or alternatively a subset of the operations may each be performed by respective separate processors, which in combination form the processor 204. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system may also include transitory or non-transitory machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

The device 202 may also include a housing 208 that may include a transmitter 210 and a receiver 212 to allow transmission and reception of data between the device 202 and a remote location. The transmitter 210 and receiver 212 may be combined into a transceiver 214. An antenna 216 may be attached to the housing 208 and electrically coupled to the transceiver 214. The device 202 may also include (not shown) multiple transmitters, multiple receivers, multiple transceivers, and/or multiple antennas, which may be utilized during MIMO communications, for example.

The device 202 may also include a signal detector 218 that may be used in an effort to detect and quantify the level of signals received by the transceiver 214. The signal detector 218 may detect such signals as total energy, energy per subcarrier per symbol, power spectral density and other signals. The device 202 may also include a digital signal processor (DSP) 220 for use in processing signals. The DSP 220 may be configured to generate a data unit for transmission.

The device 202 may further comprise a user interface 222 in some aspects. The user interface 222 may comprise a keypad, a microphone, a speaker, and/or a display. The user interface 222 may include any element or component that conveys information to a user of the device 202 and/or receives input from the user.

The various components of the device 202 may be coupled together by a bus system 226. The bus system 226 may include a data bus, for example, as well as a power bus, a control signal bus, and a status signal bus in addition to the data bus. Those of skill in the art will appreciate the components of the device 202 may be coupled together or accept or provide inputs to each other using some other mechanism.

Although a number of separate components are illustrated in FIG. 2, those of skill in the art will recognize that one or more of the components may be combined or commonly implemented. For example, the processor 204 may be used to implement not only the functionality described above with respect to the processor 204, but also to implement the functionality described above with respect to the signal detector 218 and/or the DSP 220. Further, each of the components illustrated in FIG. 2 may be implemented using a plurality of separate elements.

As discussed above, the device 202 may comprise either or both of the STAs 102a and 102b, and may be used to transmit and/or receive communications. The communications exchanged between devices in a wireless network may include data units which may comprise packets or frames. In some aspects, the data units may include data frames, control frames, and/or management frames. Data frames may be used for transmitting data from a BS, AP and/or a STA to other BSs, APs and/or STAs. Control frames may be used together with data frames for performing various operations and for reliably delivering data (e.g., acknowledging receipt of data, polling of BSs, area-clearing operations, channel acquisition, carrier-sensing maintenance functions, etc.). Management frames may be used for various supervisory functions (e.g., for joining and departing from wireless networks, etc.).

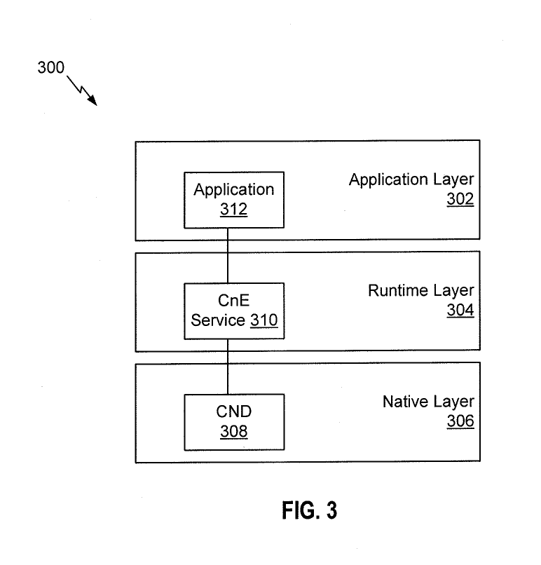

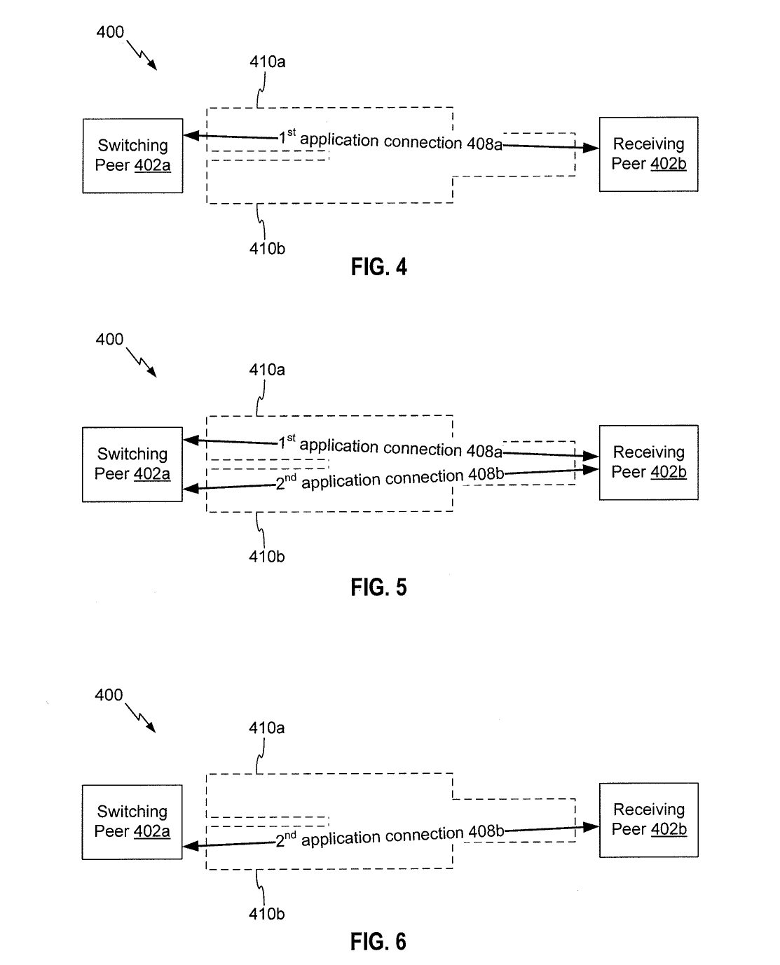

FIG. 3 is a diagram illustrating an exemplary architecture of the communication device of FIG. 2, in accordance with some implementations. The device 300 may comprise one or both of the STAs 102a and 102b, as shown in more detail by the wireless device 202 of FIG. 2. The device 300 may be configured to provide seamless handoff at an application layer within the device 300 between disparate access networks for an interactive application running on the device 300. Those skilled in the art will appreciate that the device 300 may have more components than illustrated in FIG. 3. The device 300 includes only those components useful for describing some prominent features of implementations within the scope of the claims. In some implementations, the device 300 may be configured to perform method(s) as will be described in connection with FIGS. 4-17. Moreover, because such handoffs occur at the application layer within the communication device, rather than at the network level, handoff requirements may be relaxed. For example, instead of requiring handoff to be completed within milliseconds at the network layer to avoid perceptible changes, at the application layer the applications may tolerate as much as 100 milliseconds before an end user notices any problem or lag. This may improve user perception of the application. Such perceptible changes when handoff is not completed within several milliseconds are described in Ries, Michal, Philipp Svodoba, and Markus Rupp. “Empirical study of subjective quality for massive multiplayer games.” Systems, Signals and Image Processing, 2008. IWSSIP 2008. 15^{th} International Conference on IEEE, 2008.

Device 300 may include an application layer 302, a runtime layer 304 and a native layer 306. An interactive media application 312 may run on the application layer 302. Non-limiting examples of the application 312 may include Tango messenger, Face Time, Skype, Duobango, Jitsi or WebRTC or any other interactive media application. A connectivity engine (CnE) service 310 may run on the runtime layer 304, and a connectivity daemon (CND) 308 may run on the native layer 306. In a first state, the interactive media application 312 running on the device 300 may communicate with another device (not shown) over a first access network connection, e.g., a 3G cellular access network or other network type. When another, second access network connection, e.g., a Wi-Fi or other access network, becomes available, the CND 308 may be configured to produce an access network availability indication based on metrics associated with one or both of the first and second access networks, for example, Wi-Fi quality estimation (WQE) techniques where channel quality metrics may be determined according to measurements made on at least one of a physical layer, a medium access control (MAC) layer and a transport layer of the Wi-Fi interface. This indication may be communicated upward to the CnE service 310 in the runtime layer 304. The CnE service 310 may be configured to then communicate a message to the application 312 on the application layer 302 indicating an intent (i.e. a CONNECTIVITY_ACTION intent message) to modify a connection with one or more access networks, e.g., stop using the first access network and start using the second access network or vice versa. The application 312 may receive this intent message and begin the seamless handoff at the application layer 302 between the disparate access networks, as will be described in more detail in connection with FIGS. 4-6 below

FIG. 4 illustrates an exemplary communication system in which a second access network becomes available while communicating over a first access network connection, in accordance with some implementations. Communication system 400 may include a switching peer device 402a and a receiving (Rx) peer device 402b that initially communicate with one another via an interactive application over a first access network 410a using a first application connection 408a. The communication system 400 may additionally include a second access network 410b, over which the switching and receiving peers 402a and 402b do not yet communicate but that becomes accessible to the switching and receiving peers 402a and 402b. The term “switching peer” may correspond to the device that will make a first determination to switch access networks, while the term “receiving peer” may correspond to the device receiving such a determination. However, both devices may be configured to send and receive data. The switching peer 402a may correspond to one of the STAs 102a and 102b, while the receiving peer 402b may correspond to the other of the STAs 102a and 102b in FIG. 1, for example. Both peers 402a and 402b may have an architecture as previously described in connection with FIG. 3. In communication system 400, a CnE of the switching peer 402a may detect the second access network 410b as a preferred connection and may send a new change indication to the interactive application running on the switching peer's application layer. The CnE may then update the default access network for the switching peer 402a. In addition or in the alternative to the second access network 410b being detected, a quickly degrading bandwidth over the first application connection 408a may also function as a suitable trigger for the CnE sending a new change indication to the interactive application.

FIG. 5 illustrates the exemplary communication system of FIG. 4 where a second access network connection is established while communicating over the first access network connection, in accordance with some implementations. In FIG. 5, the interactive application running on the switching peer's (402a) application layer (see FIG. 3) establishes a second application connection 408b for the already-established active session. In some implementations, the second application connection 408b may use or reuse the same security context (e.g., the same security settings, protocols, and access key(s)) previously established for the first application connection 408b to the receiving peer 402b. Thus, a separate security session or context is not required for secure communication over the second application connection 408b, even though the second application connection 408b may be associated with a network provided by a different network provider than the first application connection 408a. The receiving peer 402b may use the establishment of this second application connection 408b as an indication of an upcoming soft handoff to be conducted at the receiving peer's application layer. In some implementations, session initiation (SIP) protocols or session description (SDP) protocols could be utilized to hand off media streams over the new, e.g., second application connection. For example, the switching peer 402a may send a new media description in an SDP offer. The receiving peer may accept the offer with an SDP answer. Such an exemplary implementation may assume the presence of SIP servers in each of the switching and receiving peers' respective domains.

Once the second application connection 408b is established, both the first and second application connections 408a and 408b may be utilized to communicate the session data between the switching peer 402a and the receiving peer 402b. With both application connections established, the switching peer 402a and the receiving peer 402b may replicate their transmissions over the pre-existing application connection (first application connection 408a) and the new application connection (second application connection 408b). In some implementations, replication may be understood to mean that exactly the same data packets may be sent over both the first application connection 408a and the second application connection 408b. Such a replicated data flow may be termed a repair data flow and transmitting the replicated data flow along with the original data flow may be called bicasting. By replicating transmission data, one or both of the switching peer 402a and the receiving peer 402b may characterize the latency and throughput of each of the first application connection 408a and the second application connection 408b. An additional benefit of replicating the transmission data is the increased availability and diversity provided by having two independent data paths between the peers. One or both of the switching peer 402a and the receiving peer 402b may indicate to the other peer the rate at which it receives data from the other peer for each application connection. For example, the switching peer 402a may indicate to the receiving peer 402b the rate at which the switching peer 402a receives data from the receiving peer 402b on each of the first and second application connections 408a and 408b, and vice versa. In this way, each of the peers may receive information as to the latency and throughput of communications in each direction over each of the first and second application connections 408a and 408b.

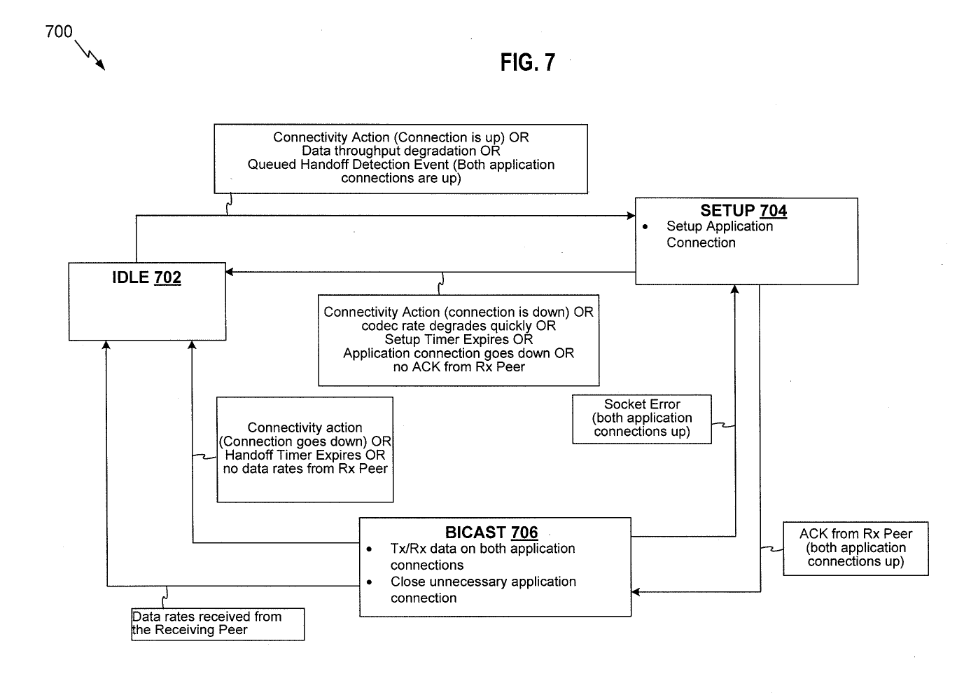

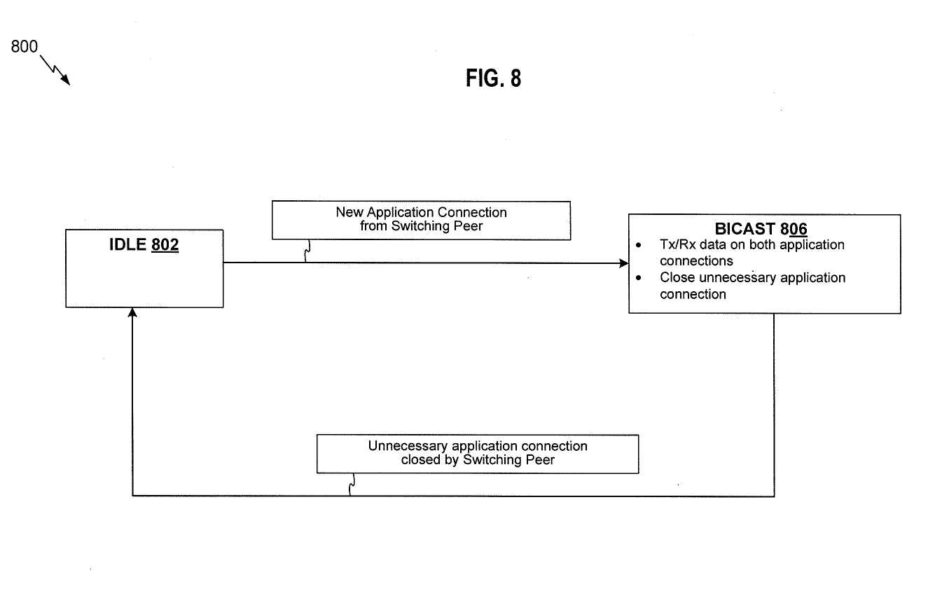

FIG. 6 illustrates the exemplary communication system of FIG. 5 where the first access network connection is closed while communicating over the second access network connection, in accordance with some implementations. The process of closing one of the two access network connections may also be called “paring.” In FIG. 6, based on the latency and throughput information determined as previously described in connection with FIG. 5, both of the switching peer 402a and the receiving peer 402b may determine if and when the new, e.g., one of the first application connection 408a and the second application connection 408b is sufficient to support the active session alone (e.g., individually), and indicates to the other peer that determination. Each of the switching peer 402a and the receiving peer 402b may independently perform this paring decision for its transmitted data. In some implementations, this paring decision may be performed periodically by one or both of the switching peer 402a and the receiving peer 402b. Where the data flows across either of the first or second application connections 408a/408b do not contain sufficient data to reliably perform the paring decision at the time for a particular periodic determination, additional bits or data (e.g., dummy bits or dummy data) may be generated and transmitted in the particular data flow(s) for the purpose of such a determination. Each of the switching peer 402a and the receiving peer 402b may close an application connection if the Switching Peer has selected that access network connection for termination or either Peer detects a network failure, i.e. receiving an internet control message protocol (ICMP) destination unreachable packet. As shown in FIG. 6, for example only, the second application connection 408b has been selected to remain open, while the first application connection 408a has been pared. In order to better understand the transitions that may occur within either of the switching peer 402a and the receiving peer 402b, a state diagram for each will now be described in connection with FIGS. 7 and 8, respectively.

FIG. 7 is an exemplary state diagram for the switching peer of FIGS. 4-6, in accordance with some implementations. As shown, FIG. 7 may include at least three states: an idle state 702, a setup state 704 and a bicast state 706. The switching peer 402a may be initialized in the idle state 702 with an access network connection, e.g., a video chat session over the first application connection 408a, as previously described in connection with FIG. 4. Upon internally receiving a message indicating an intent to modify an access network connection at the application layer, the switching peer 402a may transition to the setup state 704 if both the first and second access networks 410a and 410b are up (e.g., currently available for communicating). The switching peer 402a may also transition from the idle state 702 to the setup state 704 if there is a queued handoff detection event, if the application detects bandwidth, latency, or data throughput degradation beyond a predetermined threshold or degradation occurring at a rate faster than a predetermined rate on an already existing access network connection. In some implementations, a variation in the determined latency or data throughput (i.e., jitter) exceeding a predetermined static, adjustable or variable range may also provide a trigger for transitioning to the setup state 704.

Once in the setup state 704, the switching peer 402a may set up the new application connection by replicating the existing application connection on the new access network connection. The switching peer 402a may also set a setup timer and wait for an acknowledge message (ACK) from the receiving peer 402b. Situations in which the switching peer 402a may transition back to the idle state 702 include receiving a CONNECTIVITY_ACTION intent message that an access network is down, a received byte, codec or data rate at the switching peer 402a is dropping quickly (e.g., deteriorating faster than a predetermined threshold rate or deteriorating below a predetermined threshold), or expiration of the setup timer. From the setup state 704, the switching peer 402a may transition to the bicast state 706 upon receiving the ACK message from the receiving peer 402b if both of the first and second access networks 410a and 410b are still up.

Once in the bicast state 706, the switching peer 402a may set a bicast timer and wait for the channel quality metrics indication (e.g,. latency, data rates, and/or throughput information) from the receiving peer 402b. If the switching peer 402a receives the channel quality information from the receiving peer 402b before expiration of the bicast timer, the switching peer 402a may close the unnecessary, agreed upon application connection using a particular access network connection as previously described in connection with FIG. 6. While in the bicast state 706, the switching peer 402a may send and receive the replicated data on both of the first and second application connections 408a and 408b. From the bicast state 706, the switching peer 402a may transition back to the setup state 704 if there is a socket error and both access networks are up. From the bicast state 706, the switching peer 402a may transition to the idle state 702 upon closing the unnecessary connection. The switching peer 402a may also transition from the bicast state 706 to the idle state 702 upon expiration of the bicast timer or upon receiving a CONNECTIVITY_ACTION intent message indicating that one of the first or second access networks 410a and 410b are down.

FIG. 8 is an exemplary state diagram for the receiving peer of FIGS. 4-6, in accordance with some implementations. As shown, FIG. 8 may include at least two states: an idle state 802 and a bicast state 806. The receiving peer 402b may be initialized in the idle state 802 with an access network connection, e.g., a video chat session over the first application connection 408a, as previously described in connection with FIG. 4. Upon receiving the message indicating an intent to modify an access network connection at the application layer from the switching peer 402athe receiving peer 402b may transition to the bicast state 706. Once in the bicast state 806, the receiving peer 402b may replicate the existing application connection on the new access network connection. The receiving peer 402b may send and receive the replicated data on both of the first and second application connections 408a and 408b. The receiving peer 402b may update connection throughput and latency metrics for both the first and second application connections 408a and 408b. Upon expiration of a measurement window, the receiving peer 402b may send the updated throughput and latency information for each application connection to the switching peer 402a. If the receiving peer 402b receives an application connection closure indication from the switching peer 402a, the receiving peer 402b may close the unnecessary, agreed upon application connection as previously described in connection with FIG. 6. The receiving peer 806 may then transition back to the idle state 802.

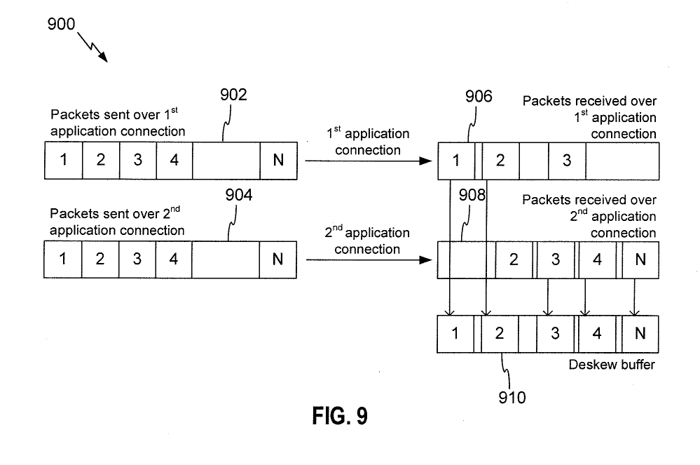

Since, in some implementations, the same data will be transmitted and received over both of the first and second application connections 408a and 408b, both the switching peer 402a and the receiving peer 402b may include a deskew buffer for placing received data packets in the correct order without duplication, as will be described in more detail in connection with FIG. 9 below.

FIG. 9 is a diagram illustrating an exemplary operation of a deskew buffer, in accordance with some implementations. The operation of a deskew buffer 910 as described in diagram 900 is applicable to both the switching peer 402a and the receiving peer 402b as previously described in connection with FIGS. 4-8 as well as STAs 102a and 102b in FIG. 1, for example. Diagram 900 includes a first transmit buffer 902 and a second transmit buffer 904 which may be located in the switching peer 402a, for example. The first transmit buffer 902 may be configured to temporarily store queued data to be transmitted over a first access network connection, for example the first application connection 408a as shown in FIG. 5. Likewise, the second transmit buffer 904 may be configured to temporarily store queued data to be transmitted over a second access network connection, for example the second application connection 408b as shown in FIG. 5. As previously described, in some implementations, the data transmitted over the first access network connection may be replicated such that the exact same data is transmitted over the second access network connection, as may be shown by data packets, 1, 2, 3, 4, and N queued in the same order in each of the first and second transmit buffers 902 and 904. In some other implementations, the data transmitted over the first access network connection may be at least partially different from the data transmitted over the second access network connection, e.g., at least a portion of data transmitted over one of the first and second access networks may comprise at least a subset of the data transmitted over the other of the first and second access networks.

The diagram 900 may additionally include a first receive buffer 906, a second receive buffer 908 and a deskew buffer 910 which may be located in the receiving peer 402b, for example. The first receive buffer 906 may be configured to temporarily store data received over the first application connection. Likewise, the second receive buffer 908 may be configured to temporarily store data received over a second application connection. Because the data received over the second application connection may be a replicated version of the data received over the first application connection, the deskew buffer 910 may be configured to place the received data packets in the correct order without duplication. For example, the deskew buffer may queue each ordered data packet from one of the first and second receive buffers 906 and 908 based on which receive buffer receives the particular uncorrupted data packet first. Where the data transmitted over the first and second access network connections are not identical, under some circumstances, only one of the first and second access network connections may transmit a particular data packet. In such a case, if the particular data packet is received in a corrupted state, since that data packet was not also transmitted across the other access network connection, that data packet may be retransmitted over the same and/or the other access network connection in order to avoid permanent loss of the information located in the corrupted data packet.

As shown, data packet 1 is received by the first receive buffer 906 but is not received by the second receive buffer 908 for whatever reason. Data packet 2 is also received by the first receive buffer 906 before it is received by the second receive buffer 908. Thus, as shown by the downward arrows, each of data packets 1 and 2 are placed in the deskew buffer 910 from the first receive buffer 906. However, as shown, data packets 3, 4, and N are received in rapid order by the second receive buffer 908. Because data packet 3 is received at the second receive buffer 908 before it is received at the first receive buffer 906, data packet 3 is placed in the deskew buffer 910 from the second receive buffer 908, as shown by the downward arrow. Similarly, data packets 4 and N are received at the second receive buffer 908 and are not received at the first receive buffer 906 for whatever reason. Such reasons may include drastically increased latency over the first access network connection or loss of the data packets altogether while being transmitted over the first application connection. Thus, data packets 4 and N are placed in the deskew buffer 910 from the second receive buffer 908, as shown by the downward arrows. Thus, the deskew buffer 910 allows each received data packet to be placed in the correct order regardless of when or over which application connection the data packets are received.

In some implementations, one or more particular packet(s) may be received in a corrupted state from each of the first and second connections. In such a case, a processor in the peer receiving the packets may be configured to repair the corrupted received packet(s) for placing into the deskew buffer 910 based on the one or more corrupted packets received from each of the first and second connections. For example, the processor may be configured to compare and/or correlate one or more bits within a particular corrupted packet as received from each of the first and second connections to extrapolate, infer or determine one or more missing or corrupted bits. Once the missing or corrupted bits are extrapolated, inferred, or determined, the repaired packet may be placed at the appropriate spot and/or in the correct order within the deskew buffer 910.

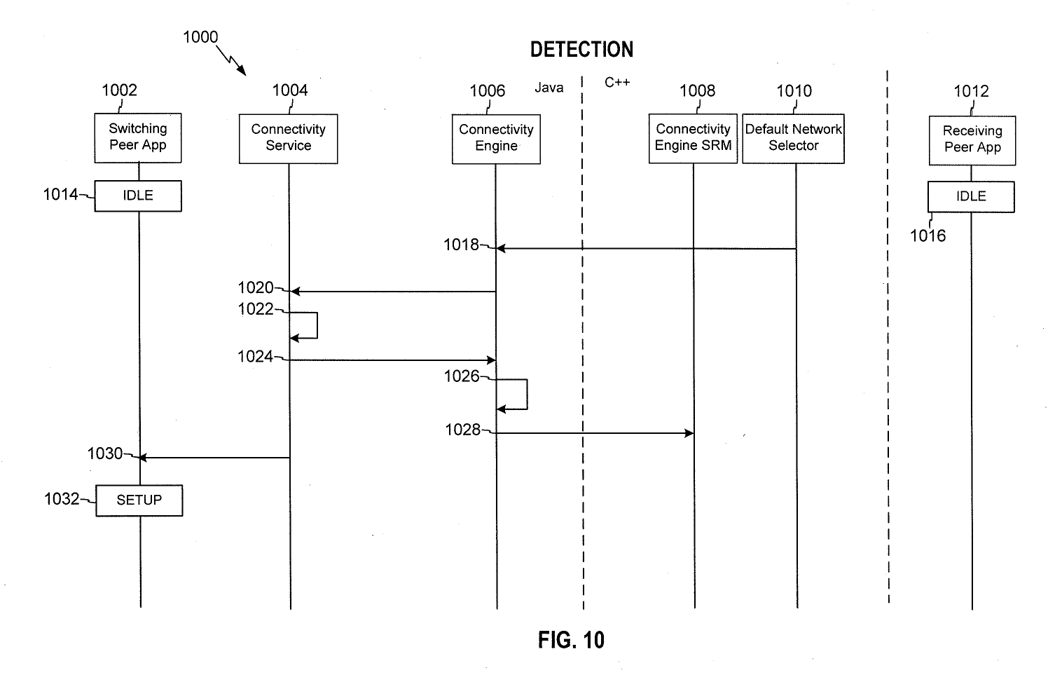

FIG. 10 illustrates an exemplary call flow diagram for detection of a second access network connection while communicating over a first access network connection, in accordance with some implementations. The call flow diagram 1000 may correspond to the detection of a second access network as previously described in connection with FIG. 4. The call flow diagram 1000 may include the following entities within the switching peer 402a as previously described: a switching peer application 1002, a connectivity service 1004, a connectivity engine 1006, a connectivity engine system resource manager (SRM) 1008, and a default access network connection selector 1010. As shown, each of the switching peer application 1002, the connectivity service 1004 and the connectivity engine 1006 may utilize Java. However, the present application is not so limited and these entities may utilize any other suitable programming language. Likewise, each of the connectivity engine system resource manager 1008 and the default access network connection selector 1010 may utilize C++, or alternatively, any other suitable programming language. The call flow diagram 1000 additionally includes the receiving peer application 1012, which runs on the application layer of the receiving peer 402b. For the duration of the call flow diagram 1000, the receiving peer application 1012 may remain in its initialized idle state 1016, as previously described in connection with the receiving peer state diagram 800 of FIG. 8. The switching peer application may also be initialized in the idle state 1014, as previously described in connection with the switching peer state diagram 700 of FIG. 7. A new, possibly preferred, access network may be detected as being available by the switching peer 402a. Thus, at operation 1018 the default access network connection selector 1010 may send a request to set a default route to the connectivity engine 1006 (CNE_REQUEST_SET_DEFAULT_ROUTE_MSG). The connectivity engine 1006 may then send a message to the connectivity service 1004 indicating a switch of the connectivity route at operation 1020 (EVENT_CONNECTIVITY_SWITCH). In response, at operation 1022 the connectivity service 1004 may set the default access network for the switching peer 402a (SetDefaultNetwork( )). The connectivity service 1004 may then send a broadcast intent message to the connectivity engine 1006 indicating the default access network set by the connectivity service 1004 at operation 1024 (CONNECTIVITY_ACTION). In response, at operation 1026 the connectivity engine 1006 may update the default access network for the switching peer 402a (updateDefaultNetwork( )). The connectivity engine 1006 may then send a request to update the default access network information to the connectivity engine system resource manager 1008 at operation 1028 (CNE_REQUEST_UPDATE_DEFAULT_NETWORK_INFO). The connectivity service 1004 may then send a broadcast intent message to the switching peer application 1002 indicating the default access network set by the connectivity service 1004 at operation 1030 (CONNECTIVITY_ACTION). At operation 1032 the switching peer application 1002 may then transition to the setup mode as previously described in connection with the switching peer state diagram 700 of FIG. 7.

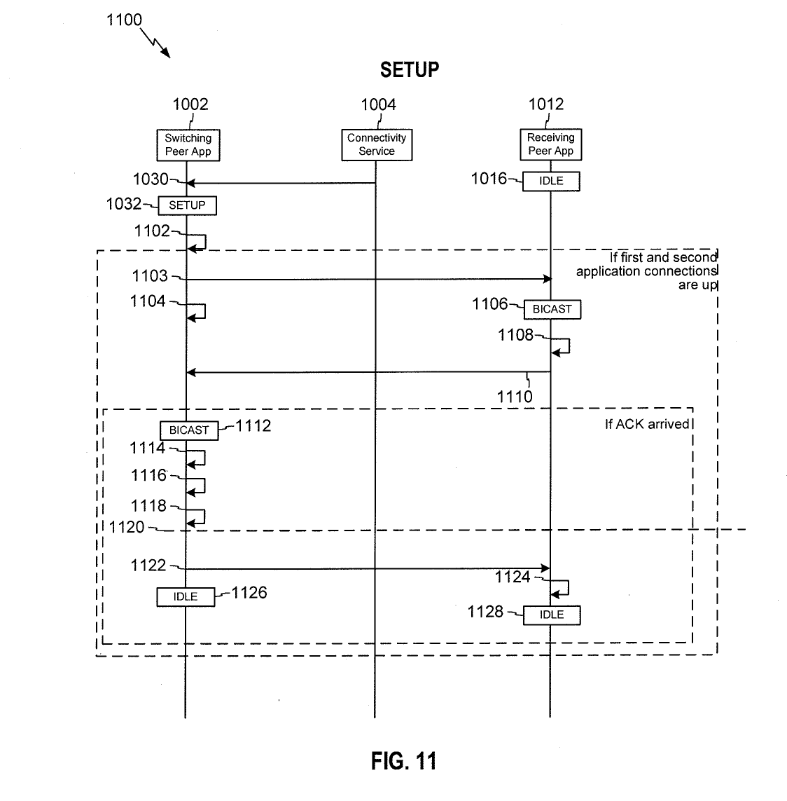

FIG. 11 illustrates an exemplary call flow diagram for a setup of a second application layer connection using the second access network connection while communicating over a first access network connection, in accordance with some implementations. The call flow diagram 1100 may correspond to the situation previously described in connection with FIG. 5. The call flow diagram 1100 continues where the call flow diagram 1000 of FIG. 10 left off and includes the switching peer application 1002 and the connectivity service 1004 within the switching peer, and the receiving peer application 1012 within the receiving peer. The call flow diagram 1100 shows the messaging operation 1030 and transition to the setup state at operation 1032, as well as the initialized idle state for the receiving peer application 1012 at operation block 1016, as previously shown in FIG. 10, to indicate the continuity between the call flow diagram 1000 and the call flow diagram 1100.

Thus, the call flow diagram 1100 may continue with operation 1102 which includes enumerating the access network connections. For example, the switching peer application 1002 may determine the first access network connection (e.g., a 3G, 4G, or 4G LTE connection) is available and associated with a first IP address, and that the second access network connection (e.g., a Wi-Fi connection) is available and associated with a second IP address. At this point, if both of the first and second access networks are up, the call flow continues with operation 1103 where the switching peer application 1002 sends an initialization packet to the receiving peer application 1012 over the new, i.e., second, access network connection to setup an application connection. This may function as a notification to the receiving peer application 1012 that the second application connection has been established by the switching peer application 1002. The switching peer application may then set a setup timer at operation 1104 which will define a time limit in which the switching peer application 1002 may expect to receive an acknowledgement of the initialization of the second application connection from the receiving peer application 1012.

Upon receiving the initialization packet of operation 1103, the receiving peer application 1012 may transition to the bicast state at operation 1106, as previously described in connection with the state diagram of FIG. 8. The receiving peer application 1012 may then link the deskew buffer to receive buffers associated with the first and second application connections, as previously described in connection with FIG. 9. The receiving peer application 1012 may then transmit an acknowledge message (ACK) 1110 to the switching peer acknowledging the transition to the bicast state. When the ACK message is received by the switching peer application 1002, the switching peer application 1002 may itself transition to the bicast state at operation 1112, as previously described in connection with the state diagram of FIG. 7. The switching peer application 1002 may then link its deskew buffer to receive buffers associated with the first and second application connections at operation 1114, set a bicast timer to set a time limit within which the switching peer application 1002 can expect to receive the latency and throughput information from the receiving peer application 1012 in operation 1116, and cancel the setup timer at operation 1118. As a reference point, although the setup timer has been canceled, operation 1120 illustrates the point in time where the setup timer would have expired, had the ACK message not been received at operation 1110.

At operation 1122, a message may be sent to the receiving peer application 1012 indicating that the unneeded application connection may be closed, as previously described in connection with FIG. 6. The switching peer application 1002 may close the appropriate application connection from its end and transition to the idle state at operation 1126, as previously described in connection with FIG. 7. The receiving peer application 1012 may then close that application connection from its end at operation 1124, and transition to the idle state at operation 1128, as previously described in connection with FIG. 8.

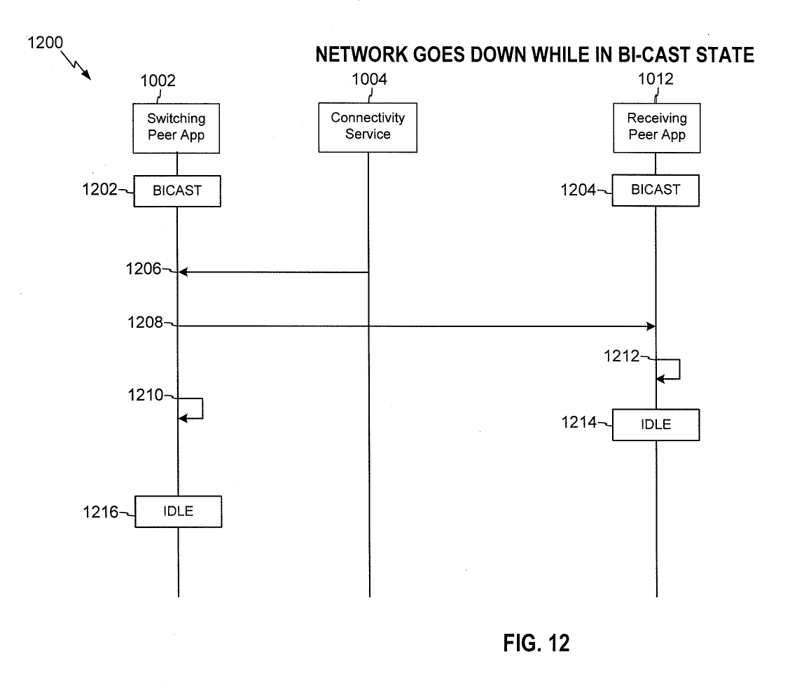

FIG. 12 illustrates an exemplary call flow diagram 1200 for a condition where an access network connection goes down while in the bicast state, in accordance with some implementations. Like call flow diagram 1100 of FIG. 11, the call flow diagram 1200 of FIG. 12 includes the switching peer application 1002 and the connectivity service 1004 within the switching peer, and the receiving peer application 1012 within the receiving peer. The call flow begins with the switching peer application 1002 in the bicast state 1202 and the receiving peer application 1012 in the bicast state 1204. If the switching peer application senses that one of the first and second access networks is down while in the bicast state, the connectivity service 1004 may send a broadcast intent message to the switching peer application 1002 at operation 1206. In response, the switching peer application 1002 may send a message to the receiving peer application 1012 indicating that the down application connection for the access network connection may be closed at operation 1208. The switching peer application 1002 may then close down the application connection that uses the down access network from its end and notify the receiving peer 1012 at operation 1208, and cancel the bicast timer at operation 1210. The receiving peer application 1012 may then close down the application connection from its end at operation 1212 and transition to the idle state 1214. The switching peer application 1002 may then transition to the idle state at operation 1216.

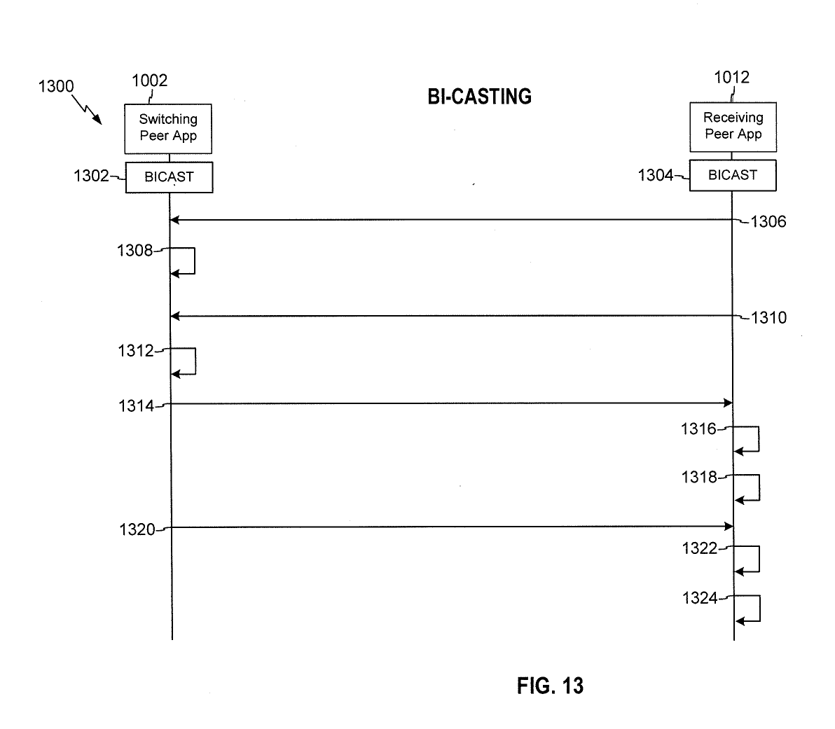

FIG. 13 illustrates an exemplary call flow diagram of the bicast state as described in FIG. 5, in accordance with some implementations. The call flow diagram 1300 may include the switching peer application 1002 and the receiving peer application 1012, each of which may begin the call flow diagram in respective bicast states 1302 and 1304. At operation 1306, the receiving peer application 1012 may send data over the first, pre-existing access network connection to the switching peer application 1002 at operation 1306. At operation 1308, the switching peer application 1002 may place the data packet in its deskew buffer if the data packet has not previously arrived on the second application connection, as previously described in connection with FIG. 9. Similarly, the receiving peer application 1012 may send data over the second application connection to the switching peer application 1002 at operation 1310. At operation 1312, the switching peer application 1002 may place the data packet in the deskew buffer if it has not previously arrived on the first application connection.

Likewise, at operation 1314 the switching peer application 1002 may send data on the first, pre-existing application connection to the receiving peer application 1012. At operation 1316 the receiving peer application 1012 may place the data packet in its deskew buffer if the data packet has not previously arrived on the second access network connection. At operation 1318, the latency and throughput metrics may be updated for the first application connection. At operation 1320 the switching peer application 1002 may send data on the second application connection to the receiving peer application 1012. At operation 1322 the receiving peer application 1012 may place the data packet in its deskew buffer if the data packet has not previously arrived on the first application connection. At operation 1324, the latency and throughput metrics may be updated for the second application connection.

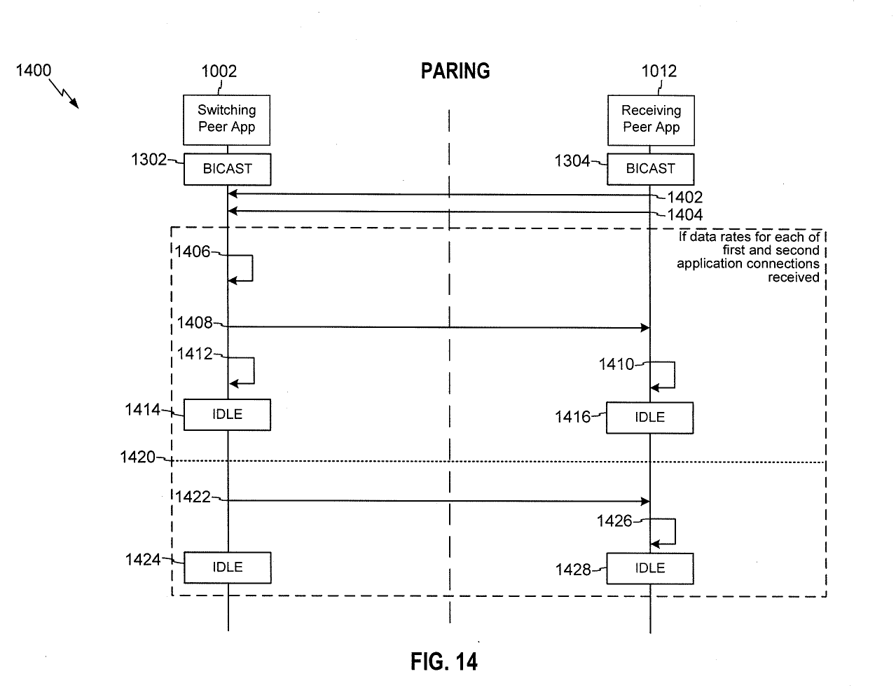

FIG. 14 illustrates an exemplary call flow diagram for the paring procedure as described in FIG. 6, in accordance with some implementations. The call flow diagram 1400 may include the switching peer application 1002 and the receiving peer application 1012, each of which may begin the call flow diagram in the respective bicast states 1302 and 1304 described in FIG. 13 to show the continuity between call flow diagram 1300 and call flow diagram 1400. At operation 1402 the receiving peer application 1012 may send the determined data rate for the first application connection to the switching peer application 1002 over the first application connection. At operation 1404 the receiving peer application 1012 may send the determined data rate for the second application connection to the switching peer application 1002 over the second access network connection. If both data rates are received by the switching peer application 1002, at operation 1406 the switching peer application 1002 may compare the rates, giving a configurable bias to the currently set default access network at the time of comparison. At operation 1408 the switching peer application 1002 may send a message to close the lowest rate or lowest priority application connection (as determined based on one or more previously described channel quality metrics, which may include historical network data such as past indications of those channel quality metrics) and then close that application connection from the switching peer application's side. Upon receiving the message, the receiving peer application 1012 may close the indicated application connection at operation 1410 and transition to the idle state at operation 1416. After sending the message at operation 1408, the switching peer application 1002 may cancel the bicast timer at operation 1412 and transition to the idle state at operation 1414.

For the purpose of illustration, the line 1420 indicates the time at which the bicast timer would have expired had no data rates (or in some implementations, only one data rate) been received by the switching peer application 1002 at operations 1402/1404. In such a case, at operation 1422 the switching peer may send a message indicating closing the unnecessary application connection based on access network availability to the receiving peer application 1012, close the application connection, and transition to the idle state at operation 1424. Upon receiving the message at operation 1422, the receiving peer application 1012 may close the application connection at operation 1426 and then transition to the idle state at operation 1428.

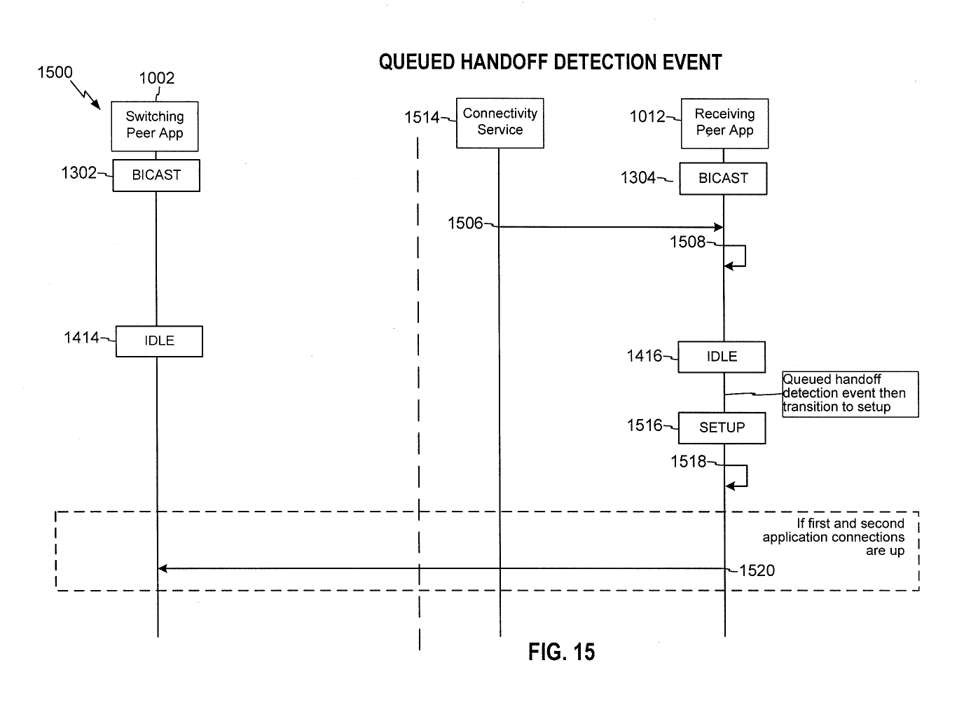

FIG. 15 illustrates an exemplary call flow diagram of a queued handoff detection event as described in FIG. 7, in accordance with some implementations. The call flow diagram 1500 may include the switching peer application 1002 as well as the receiving peer application 1012 having a connectivity service 1514. The call flow diagram 1500 may begin with the switching peer application 1002 and the receiving peer application 1012 in the respective bicast states 1302 and 1304 described in FIG. 14 to show the continuity between call flow diagram 1400 and call flow diagram 1500. At operation 1506 the connectivity service 1514 may send a message to the receiving peer application 1012 indicating an intent (e.g., a CONNECTIVITY_ACTION intent message) to queue a handoff of the receiving peer from one access network to a different access network. In some implementations, the operation 1506 may be performed in response to operation 1408 of FIG. 14 (not shown in FIG. 15) where the switching peer sent the message to close the lowest rate or lowest priority application connection and then closes that application connection from the switching peer application's 1002 side. At operation 1508 the receiving peer application 1012 may queue the handoff detection event (queueHandoffDetectionEvent( )). The switching peer application 1002 may transition to the idle state at operation 1414, as previously described in connection with FIG. 14, after closing the selected application connection. Likewise, the receiving peer application 1012 may transition to the idle state at operation 1416, as previously described in connection with FIG. 14. However, having previously queued the handoff detection event at operation 1508, the receiving peer application 1012 may detect the queued handoff detection event and transition to the setup state as a switching peer at operation 1516. The receiving peer application 1012 (which is now operating as a switching peer application) may then enumerate the access network connections at operation 1518. For example, the new switching peer application 1012 may determine the first access network connection (e.g., a 3G, 4G, or 4G LTE connection) is available and associated with a first IP address, and that the second access network connection (e.g., a Wi-Fi connection) is available and associated with a second IP address. If both the first and the second access networks are up, the new switching peer application 1012 may replicate the first application connection from the first access network connection to a second application connection making use of the second access network connection by binding it to an IP address (for the second application connection) not in use by the first access network connection and transmit data over both application connections at operation 1520.

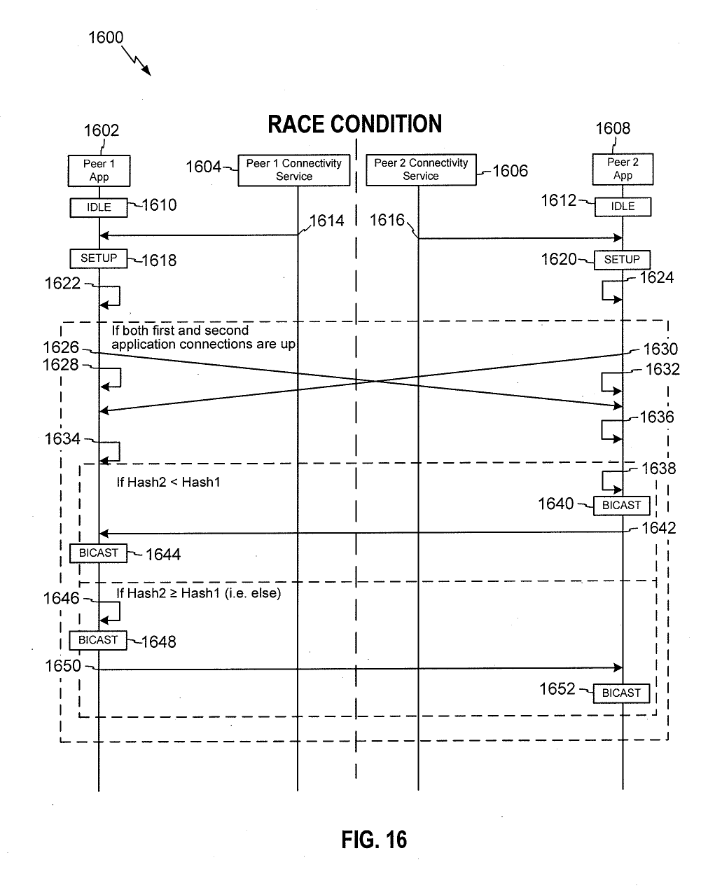

FIG. 16 illustrates an exemplary call flow diagram for a race condition where both peers attempt to perform a setup similar to that described in connection with FIG. 11, in accordance with some implementations. The call flow diagram 1600 may include a first peer application 1602 having a connectivity service 1604, and a second peer application 1608 having a connectivity service 1606. The call flow diagram 1600 may begin with the first peer application 1602 and the second peer application 1608 in respective idle states 1610 and 1612. At operation 1614 the connectivity service 1604 for the first peer application 1602 may send a message to the first peer application 1602 indicating an intent (e.g., an intent CONNECTIVITY_ACTION message) to switch the first peer from one access network to a different access network. At nearly the same time the connectivity service 1606 for the second peer application 1608 may send a message to the second peer application 1608 indicating an intent (i.e. an intent CONNECTIVITY_ACTION message) to switch the second peer from one access network to a different access network at operation 1616. At operation 1622 the first peer application 1602 may then enumerate the access network connections. Similarly, at operation 1624 the second peer application 1608 may enumerate the access network connections. For example, each of the first and second peer applications 1602 and 1608 may separately determine the first access network connection (e.g., a 3G, 4G, or 4G LTE connection) is available and associated with a first IP address, and that the second access network connection (e.g., a Wi-Fi connection) is available and associated with a second IP address.

If both the first and second access networks are up, the first peer application 1602 may replicate the first application connection to the second application connection, and bind the second application connection to an IP address not in use by the existing first access network connection, and send a first peer device id indication (e.g., id hash) and priority indication (e.g., priority bit) to the second peer application at operation 1626. Such a priority indication may be based at least in part on the above-mentioned channel quality metrics utilized to determine data throughput of either of the first or second connections. This may include sending an initialization packet over the second application connection. The first peer application may then set a setup timer at operation 1628. Likewise, at nearly the same time, the second peer application 1608 may replicate the first application connection to the second application connection, and bind the second application connection to an IP address not in use by the existing, first access network connection, and send the second peer device id indication and priority indication to the first peer application at operation 1630. This may also include sending an initialization packet over the second application connection to the first peer application 1602. The second peer application may then set a setup timer at operation 1632. The second peer application 1608 may perform a hash compare at operation 1636. At nearly the same time, the first peer application 1602 may perform a hash compare at operation 1634. In the example shown in FIG. 16, the first peer device id hash, priority indication, and/or initialization packet may arrive at the second peer device 1608 slightly before the second peer device id hash, priority indication, and/or initialization packet arrives at the first peer device 1602. Thus, if the second peer device id hash or priority indication has a smaller value than that of the first peer device, the second peer application 1608 may cancel its setup timer at operation 1638 and may transition to the bicast state at operation 1640. At this point, the second peer application 1608 may function as the receiving peer and the first peer application 1602 may function as the switching peer, as previously described. The second peer application 1608 may send an ACK message to the first peer application 1602 at operation 1642. In response, the first peer application 1602 may transition to the bicast state at operation 1644. The first and second peer applications may then operation in the bicast state, as previously described.

If, instead, the first peer device id hash or priority indication has a smaller value than that of the first peer device, the first peer application 1602 may cancel its setup timer at operation 1646 and transition to the bicast state at operation 1648. The first peer application 1602 may then send an ACK message to the second peer application 1608 at operation 1650. In response, the second peer application 1608 may transition to the bicast state at operation 1652. In this case, the first peer application 1602 may function as the receiving peer and the second peer application 1608 may function as the switching peer, as previously described.

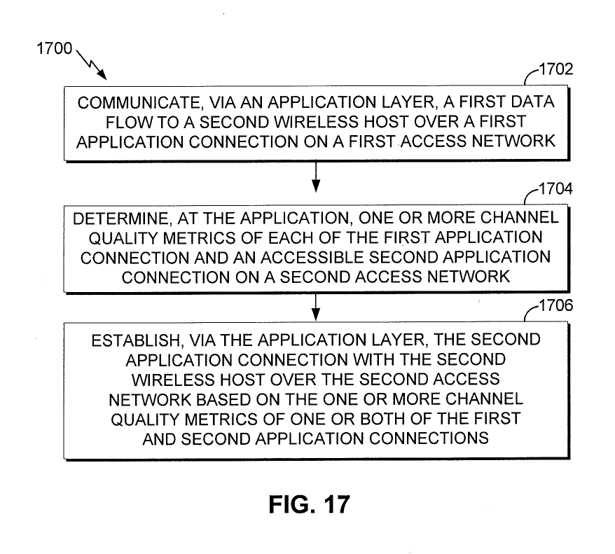

FIG. 17 is a flow chart for a method of communication, in accordance with some implementations. In some implementations, one or more of the steps in flowchart 1700 may be performed by, or in connection with, a processor and/or transmitter, such as the processor 204 and the transmitter 210 of FIG. 2, although those having ordinary skill in the art will appreciate that other components may be used to implement one or more of the steps described herein. As previously stated, the device 202 of FIG. 2 may show any of the STAs 102a and 102b in more detail. Accordingly, any of the STAs 102a and 102b of FIG. 1 may perform the method described below. Although blocks may be described as occurring in a certain order, the blocks can be reordered, blocks can be omitted, and/or additional blocks can be added.

The flowchart 1700 may begin with block 1702, which includes communicating, via an application layer, a first data flow to a second wireless host over a first application connection on a first access network. For example, as shown in FIG. 4, the application running on an application layer of the switching peer 402a may transmit a data flow to the receiving peer 402b over the first application connection 408a of the first access network 410a. The switching peer 402a may be shown in more detail as the device 300 of FIG. 3 or the device 202 of FIG. 2. Thus, block 1702 may be performed by the transmitter 210, receiver 212, or processor 204 of the device 202 of FIG. 2. The flowchart may continue with block 1704.

Block 1704 may include determining, at the application, one or more channel quality metrics of each of the first application connection and an accessible second application connection on a second access network. For example, as shown in FIG. 4, the application running on the application layer of the switching peer 402a may sense the second access network 410a and determine that the second access network 410b is accessible to the switching peer 402a and the receiving peer 402b. In addition, the application of the switching peer 402a may sense or determine one or more channel quality metrics such as an amount of packet loss, a latency, a channel power or channel quality associated with one or both of the first and second application connections 408a/408b as well as calculate or determine a data throughput. Block 1704 may be performed by the processor 204 of the device 202 of FIG. 2. The flowchart may continue with block 1706.

Block 1706 may include establishing, via the application layer, the second application connection with the second wireless host over the second access network based on the one or more channel quality metrics of one both of the first and second application connections. For example, as shown in FIGS. 5, 7, 8, 10 and/or 11, the switching peer 402a may establish the second application connection 408b of the second access network 410b.

Thus, the method(s) shown by flowchart 1700 may be utilized to provide a type of soft handoff feature from a first access network to both the first and a second access network, and then in some cases, to only one of the first and second access network, as conducted at the application (e.g., performed at the application layer) of the communication device rather than at or within the access network itself (e.g., at servers in the signal chain between the communicating wireless hosts). In this way, the method(s) shown by flowchart 1700 optimize device performance by avoiding noticeable interruptions in the service by the end user, and by avoiding any requirement of handoff processes being performed at any server or host between the end point hosts (e.g., the switching peer 402a and the receiving peer 402b).

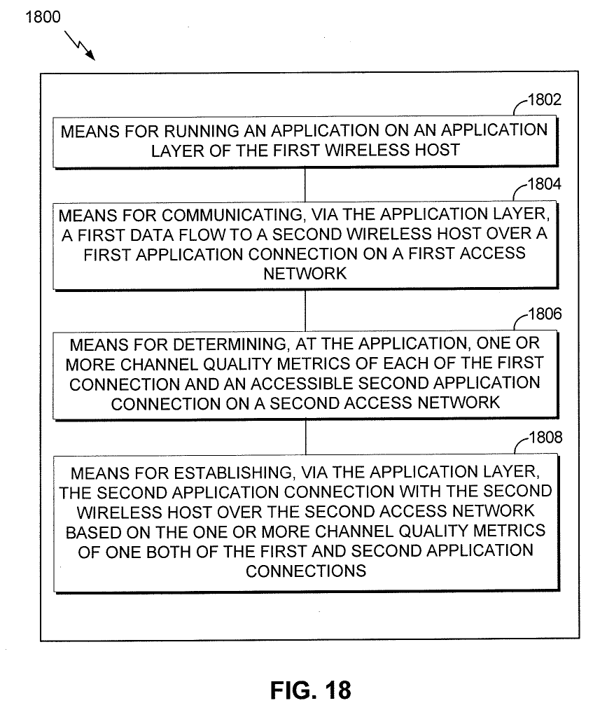

FIG. 18 is a functional block diagram of an exemplary wireless host for wireless communication, in accordance with some implementations. Those skilled in the art will appreciate that the wireless host 1800 may have more components than illustrated in FIG. 18. The wireless host 1800 includes only those components useful for describing some prominent features of implementations within the scope of the claims. In some implementations, the wireless host 1800 may be configured to perform the method(s) as previously described in flowchart 1700 in FIG. 17. The wireless host 1800 may comprise either or both of the STAs 102a and 102b shown in FIG. 1, for example, which may be shown in more detail as the device 202 shown in FIG. 2 or the switching peer 402a and the receiving peer 402b shown in FIGS. 4-6.

The wireless host 1800 comprises means 1802 for running an application on an application layer of the first wireless host. The means 1802 may comprise at least the processor 204 shown in FIG. 2, for example. In some implementations, the means 1802 may additionally comprise the memory 206 shown in FIG. 2, for example.

The wireless host 1800 may further include means 1804 for communicating, via the application layer, a first data flow to a second wireless node over a first application connection on a first access network. The means 1804 can be configured to perform one or more of the functions described above with respect to block 1702 of FIG. 17. The means 1804 may comprise one or more of the transmitter 210, the receiver 212, and the processor 204 shown in FIG. 2, for example. In some implementations, the means 1804 may additionally comprise the memory 206 shown in FIG. 2, for example.

The wireless host 1800 may further include means 1806 for determining, at the application, one or more channel quality metrics of each of the first application connection and an accessible second application connection on a second access network. In some implementations, the means 1806 can be configured to perform one or more of the functions described above with respect to block 1704 of FIG. 17. The means 1806 may comprise the processor 204 shown in FIG. 2, for example. In some implementations, the means 1806 may additionally comprise the memory 206 shown in FIG. 2, for example.

The wireless host 1800 may further include means 1808 for establishing, via the application layer, the second application connection with the second wireless node over the second access network based on the one or more channel quality metrics of one or both of the first and second application connections. In some implementations, the means 1808 can be configured to perform one or more of the functions described above with respect to block 1706 of FIG. 17. The means 1808 may comprise one or more of the processor 204, the transmitter 210, and the receiver 212 shown in FIG. 2, for example. In some implementations, the means 1808 may additionally comprise the memory 206 shown in FIG. 2, for example. In some implementations, the apparatus 1800 may additionally include means for performing any steps or functions as previously described above in connection with any of the previous figures.

A person/one having ordinary skill in the art would understand that information and signals can be represented using any of a variety of different technologies and techniques. For example, data, instructions, commands, information, signals, bits, symbols, and chips that can be referenced throughout the above description can be represented by voltages, currents, electromagnetic waves, magnetic fields or particles, optical fields or particles, or any combination thereof.

Various modifications to the implementations described in this disclosure can be readily apparent to those skilled in the art, and the generic principles defined herein can be applied to other implementations without departing from the spirit or scope of this disclosure. Thus, the disclosure is not intended to be limited to the implementations shown herein, but is to be accorded the widest scope consistent with the claims, the principles and the novel features disclosed herein. The word “exemplary” is used exclusively herein to mean “serving as an example, instance, or illustration.” Any implementation described herein as “exemplary” is not necessarily to be construed as preferred or advantageous over other implementations.

Certain features that are described in this specification in the context of separate implementations also can be implemented in combination in a single implementation. Conversely, various features that are described in the context of a single implementation also can be implemented in multiple implementations separately or in any suitable sub-combination. Moreover, although features can be described above as acting in certain combinations and even initially claimed as such, one or more features from a claimed combination can in some cases be excised from the combination, and the claimed combination can be directed to a sub-combination or variation of a sub-combination.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a web site, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Thus, in some aspects computer readable medium may comprise non-transitory computer readable medium (e.g., tangible media). In addition, in some aspects computer readable medium may comprise transitory computer readable medium (e.g., a signal). Combinations of the above should also be included within the scope of computer-readable media.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

While the foregoing is directed to aspects of the present disclosure, other and further aspects of the disclosure may be devised without departing from the basic scope thereof, and the scope thereof is determined by the claims that follow.

What is claimed is:

1. A method of communication for an application running on an application layer of a first wireless host, comprising:
communicating, via the application layer, a first data flow to a second wireless host over a first application connection on a first access network,
determining, at the application, one or more channel quality metrics of each of the first application connection and an accessible second application connection on a second access network, and
establishing, via the application layer, the second application connection with the second wireless host over the second access network based on the one or more channel quality metrics of one or both of the first and second application connections.

2. The method of claim 1, wherein the channel quality metrics for one or both of the first and second application connections comprise one or more of an amount of packet loss, a data throughput, a latency, a variation in the latency, a channel power, and a channel quality, or a combination thereof.

3. The method of claim 1, wherein the second application connection is established based on one or more of:
the determined one or more channel quality metrics of the first application connection degrading below a respective predetermined threshold or degrading faster than a respective predetermined rate;
the determined one or more channel quality metrics of the first application connection increasing above a respective predetermined threshold or increasing faster than a respective predetermined rate; and
a variation in the determined one or more channel quality metrics exceeding a respective predetermined range.

4. The method of claim 1, further comprising communicating one or more of the determined channel quality metrics to the second wireless host over one or both of the first and second application connections based on one or more of the channel quality metrics crossing a respective predetermined threshold.

5. The method of claim 1, further comprising transmitting an identity indication and a priority indication of the first wireless host to the second wireless host over one or both of the first and second application connections.

6. The method of claim 1, further comprising communicating a second data flow to the second wireless host over the established second application connection, the first and second data flows originating from the same data.

7. The method of claim 6, wherein the first data flow and the second data flow are associated with a same active session and utilize a same security context between the first wireless host and the second wireless host.

8. The method of claim 7, further comprising periodically communicating sufficient data over each of the first and second application connections to enable a determination of whether data throughput of either of the first and second application connections is sufficient to individually accommodate the active session.

9. The method of claim 1, further comprising:
selecting one of the first and second application connections for termination based on one or more of the following: the channel quality metrics associated with one or both of the first and second application connections, a selection of one of the first and second application connections for termination received from the second wireless host, and a manual selection received from a user of the first or second wireless host, and
terminating the selected application connection.

10. The method of claim 9, further comprising updating a primary application connection for the application to the unterminated application connection of the first and second application connections.

11. The method of claim 9, further comprising transmitting a message to the second wireless host instructing the second wireless host to terminate the selected application connection, wherein the message causes the second wireless host to queue a handoff of the second wireless host to the selected application connection from the other application connection.

12. The method of claim 1, further comprising:
receiving a plurality of data packets from the second wireless host over one of the first and second application connections,
receiving at least a portion of the plurality of data packets from the second wireless host over the other of the first and second application connections, and one or both of:
placing each received data packet of the plurality of data packets into a deskew buffer from one of the first and second application connections based on a receive time of each data packet from the first and second access networks, and
repairing corrupted received data packets for placing into the deskew buffer based on one or more data packets received from one or both of the first and second application connections.

13. The method of claim 1, further comprising:
transmitting a first message to the second wireless host indicating an intent to establish the second application connection, the first message including one or both of an identification value for the first wireless host and a priority value for the first wireless host,
receiving a second message from the second wireless host indicating an intent to establish the second application connection, the second message including one or both of an identification value for the second wireless host and a priority value for the second wireless host, and
establishing the second application connection utilizing a selected one of an internet protocol (IP) address provided by the first wireless host and an IP address provide by the second wireless host based on a comparison of one or both of the identification value and the priority value for the first and second wireless hosts.

14. The method of claim 1, wherein the application is a video chat application.

15. A first wireless host for wireless communication, comprising:
a processor running an application on an application layer and configured to:
communicate, via the application layer, a first data flow to a second wireless host over a first application connection on a first access network,
determine, at the application, one or more channel quality metrics of each of the first application connection and an accessible second application connection on a second access network, and
establish, via the application layer, the second application connection with the second wireless host over the second access network based on the one or more channel quality metrics of one or both of the first and second application connections.

16. The wireless host of claim 15, wherein the channel quality metrics for one or both of the first and second application connections comprise one or more of an amount of packet loss, a latency, a variation in the latency a channel power, and a channel quality, or a combination thereof.

17. The wireless host of claim 15, wherein the processor is configured to establish the second application connection based on one or more of:
the determined one or more channel quality metrics of the first application connection degrading below a respective predetermined threshold or degrading faster than a respective predetermined rate;
the determined one or more channel quality metrics of the first application connection increasing above a respective predetermined threshold or increasing faster than a respective predetermined rate; and
a variation in the determined one or more channel quality metrics exceeding a respective predetermined range.

18. The wireless host of claim 15, further comprising a transmitter configured to communicate one or more of the determined channel quality metrics to the second wireless host over one or both of the first and second application connections based on one or more of the channel quality metrics crossing a respective predetermined threshold.

19. The wireless host of claim 15, further comprising a transmitter configured to transmit an identity indication and a priority indication of the first wireless host to the second wireless host over one or both of the first and second application connections.

20. The wireless host of claim 15, further comprising a transmitter configured to communicate a second data flow to the second wireless host over the established second application connection, the first and second data flows originating from the same data.

21. The wireless host of claim 20, wherein the first data flow and the second data flow are associated with a same active session and utilize a same security context between the first wireless host and the second wireless host.

22. The wireless host of claim 21, wherein the processor is further configured to periodically communicate sufficient data over each of the first and second application connections to enable a determination of whether data throughput of either of the first and second application connections is sufficient to individually accommodate the active session.

23. The wireless host of claim 15, wherein the processor is further configured to:
select one of the first and second application connections for termination based on one or more of the following: the channel quality metrics associated with one or both of the first and second application connections, a selection of one of the first and second application connections for termination received from the second wireless host, and a manual selection received from a user of the first or second wireless host, and
terminate the selected application connection.

24. The wireless host of claim 23, wherein the processor is further configured to update a primary application connection for the application to the unterminated application connection of the first and second application connections.

25. The wireless host of claim 24, wherein the processor is further configured to transmit a message to the second wireless host instructing the second wireless host to terminate the selected application connection, wherein the message causes the second wireless host to queue a handoff of the second wireless host to the selected application connection from the other application connection.

26. The wireless host of claim 15, further comprising a receiver configured to:
receive a plurality of data packets from the second wireless host over one of the first and second application connections,
receive at least a portion of the plurality of data packets from the second wireless host over the other of the first and second application connections, and
wherein the processor is further configured to one or both of:
placing each received data packet of the plurality of data packets into a deskew buffer from one of the first and second application connections based on a receive time of each data packet from the first and second access networks, and
repairing corrupted received data packets for placing into the deskew buffer based on one or more data packets received from one or both of the first and second application connections.

27. The wireless host of claim 15, wherein the processor is further configured to:
transmit a first message to the second wireless host indicating an intent to establish the second application connection, the first message including one or both of an identification value for the first wireless host and a priority value for the first wireless host,
receive a second message from the second wireless host indicating an intent to establish the second application connection, the second message including one or both of an identification value for the second wireless host and a priority value for the second wireless host, and
establish the second application connection utilizing a selected one of an internet protocol (IP) address provided by the first wireless host and an IP address provide by the second wireless host based on a comparison of one or both of the identification value and the priority value for the first and second wireless hosts.

28. The wireless host of claim 15, wherein the application is a video chat application.

29. A non-transient, computer-readable medium comprising code that, when executed, causes a first wireless host running an application on an application layer to:
communicate, via the application layer, a first data flow to a second wireless host over a first application connection on a first access network,
determine, at the application, one or more channel quality metrics of each of the first application connection and an accessible second application connection on a second access network, and
establish, via the application layer, the second application connection with the second wireless host over the second access network based on the one or more channel quality metrics of one both of the first and second application connections.

30. The medium of claim 29, wherein the channel quality metrics for one or both of the first and second application connections comprise one or more of an amount of packet loss, a latency, a variation in the latency, a channel power, and a channel quality, or a combination thereof.

31. The medium of claim 29, wherein the second application connection is established based on one or more of:
the determined one or more channel quality metrics of the first application connection degrading below a respective predetermined threshold or degrading faster than a respective predetermined rate;
the determined one or more channel quality metrics of the first application connection increasing above a respective predetermined threshold or increasing faster than a respective predetermined rate; and
a variation in the determined one or more channel quality metrics exceeding a respective predetermined range.

32. The medium of claim 29, wherein the code, when executed, further causes the first wireless host to communicate one or more of the determined channel quality metrics to the second wireless host over one or both of the first and second application connections based on one or more of the channel quality metrics crossing a respective predetermined threshold.

33. The medium of claim 29, wherein the code, when executed, further causes the first wireless host to transmit an identity indication and a priority indication of the first wireless host to the second wireless host over one or both of the first and second application connections.

34. The medium of claim 29, wherein the code, when executed, further causes the first wireless host to communicate a second data flow to the second wireless host over the established second application connection, the first and second data flows originating from the same data.

35. The medium of claim 34, wherein the first data flow and the second data flow are associated with a same active session and utilize a same security context between the first wireless host and the second wireless host.

36. The medium of claim 35, wherein the code, when executed, further causes the first wireless host to periodically communicate sufficient data over each of the first and second application connections to enable a determination of whether data throughput of either of the first and second application connections is sufficient to individually accommodate the active session.

37. The medium of claim 29, wherein the code, when executed, further causes the first wireless host running the application thereon to:
select one of the first and second application connections for termination based on one or more of the following: the channel quality metrics associated with one or both of the first and second application connections, a selection of one of the first and second application connections for termination received from the second wireless host, and a manual selection received from a user of the first or second wireless host, and
terminate the selected application connection.

38. The medium of claim 37, wherein the code, when executed, further causes the first wireless host to update a primary application connection for the application to the unterminated application connection of the first and second application connections.

39. The medium of claim 37, wherein the code, when executed, further causes the first wireless host to transmit a message to the second wireless host instructing the second wireless host to terminate the selected application connection, wherein the message causes the second wireless host to queue a handoff of the second wireless host to the selected application connection from the other application connection.

40. The medium of claim 39, wherein the code, when executed, further causes the wireless host running the application thereon to:
receive a plurality of data packets from the second wireless host over one of the first and second application connections,
receive at least a portion of the plurality of data packets from the second wireless host over the other of the first and second application connections, and one or both of:
placing each received data packet of the plurality of data packets into a deskew buffer from one of the first and second application connections based on a receive time of each data packet from the first and second access networks, and
repairing corrupted received data packets for placing into the deskew buffer based on one or more data packets received from one or both of the first and second application connections.

41. The medium of claim 29, wherein the code, when executed, further causes the first wireless host to:
transmit a first message to the second wireless host indicating an intent to establish the second application connection, the first message including one or both of an identification value for the first wireless host and a priority value for the first wireless host,
receive a second message from the second wireless host indicating an intent to establish the second application connection, the second message including one or both of an identification value for the second wireless host and a priority value for the second wireless host, and
establish the second application connection utilizing a selected one of an internet protocol (IP) address provided by the first wireless host and an IP address provide by the second wireless host based on a comparison of one or both of the identification value and the priority value for the first and second wireless hosts.

42. The medium of claim 29, wherein the application is a video chat application.

43. A first wireless host for wireless communication, comprising:
means for running an application on an application layer of the first wireless host;
means for communicating, via the application layer, a first data flow to a second wireless host over a first application connection on a first access network;
means for determining, at the application, one or more channel quality metrics of each of the first application connection and an accessible second application connection on a second access network; and
means for establishing, via the application layer, the second application connection with the second wireless host over the second access network based on the one or more channel quality metrics of one both of the first and second application connections.

44. The first wireless host of claim 40, wherein the channel quality metrics for one or both of the first and second application connections comprise one or more of an amount of packet loss, a latency, a variation in the latency, a channel power, and a channel quality, or a combination thereof.

45. The first wireless host of claim 40, wherein the second application connection is established based on one or more of:
the determined one or more channel quality metrics of the first application connection degrading below a respective predetermined threshold or degrading faster than a respective predetermined rate;
the determined one or more channel quality metrics of the first application connection increasing above a respective predetermined threshold or increasing faster than a respective predetermined rate; and
a variation in the determined one or more channel quality metrics exceeding a respective predetermined range.

46. The first wireless host of claim 40 further comprising means for communicating one or more of the determined channel quality metrics to the second wireless host over one or both of the first and second application connections based on one or more of the channel quality metrics crossing a respective predetermined threshold.

47. The first wireless host of claim 40, further comprising means for transmitting an identity indication and a priority indication of the first wireless host to the second wireless host over one or both of the first and second application connections.

48. The first wireless host of claim 40, further comprising means for communicating a second data flow to the second wireless host over the established second application connection, the first and second data flows originating from the same data.

49. The first wireless host of claim 45, wherein the first data flow and the second data flow are associated with a same active session and utilize a same security context between the first wireless host and the second wireless host.

50. The first wireless host of claim 46, further comprising means for periodically communicating sufficient data over each of the first and second application connections to enable a determination of whether data throughput of either of the first and second application connections is sufficient to individually accommodate the active session.

51. The first wireless host of claim 40, further comprising:
means for selecting one of the first and second application connections for termination based on one or more of the following: the channel quality metrics associated with one or more of the first and second application connections, a selection of one of the first and second application connections for termination received from the second wireless host, and a manual selection received from a user of the first or second wireless host; and
means for terminating the selected application connection.

52. The first wireless host of claim 48, further comprising means for updating a primary application connection for the application to the unterminated application connection of the first and second application connections.

53. The first wireless host of claim 48, further comprising means for transmitting a message to the second wireless host instructing the second wireless host to terminate the selected application connection, wherein the message causes the second wireless host to queue a handoff of the second wireless host to the selected application connection from the other application connection.

54. The wireless host of claim 40, further comprising:
means for receiving a plurality of data packets from the second wireless host over one of the first and second application connections,
means for receiving at least a portion of the plurality of data packets from the second wireless host over the other of the first and second application connections, and one or both of:
means for placing each received data packet of the plurality of data packets into a deskew buffer from one of the first and second application connections based on a receive time of each data packet from the first and second access networks; and
means for repairing corrupted received data packets for placing into the deskew buffer based on one or more data packets received from one or both of the first and second application connections.

55. The wireless host of claim 40, further comprising:
means for transmitting a first message to the second wireless host indicating an intent to establish the second application connection, the first message including one or both of an identification value for the first wireless host and a priority value for the first wireless host,
means for receiving a second message from the second wireless host indicating an intent to establish the second application connection, the second message including one or both of an identification value for the second wireless host and a priority value for the second wireless host, and
means for establishing the second application connection utilizing a selected one of an internet protocol (IP) address provided by the first wireless host and an IP address provide by the second wireless host based on a comparison of one or both of the identification value and the priority value for the first and second wireless hosts.

56. The wireless host of claim 40, wherein the application is a video chat application.
